(19) United States
(12) Patent Application Publication
(10) Pub. No.: US 2006/0164921 A1
(43) Pub. Date: Jul. 27, 2006

(54) Radio-controlled wrist watch with metal dial

(75) Inventors: Roger Gunnarsson, Alpirsbach (DE); Guenter Megner, Uhldingen (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Junghans Uhren Gmbh, Schramberg (DE)

(21) Appl. No.: 11/314,248

(22) Filed: Dec. 22, 2005

(30) Foreign Application Priority Data
Dec. 22, 2004 (DE) 10 2004 063 121.2

(51) Int. Cl. G04C 11/02; G04B 37/00

(52) U.S. Cl. 368/47; 368/281

(57) ABSTRACT

A radio-controlled wrist watch includes a watch case in which are housed a brass dial and a signal-receiving antenna, such as a lamellar antenna. The dial defines a center axis, and the antenna is spaced at an axial distance from the dial of more than 0.5 mm, e.g., 1 to 4 mm, more preferably 1 to 3 mm.

### BACKGROUND

The invention relates to a radio-controlled wrist watch having an antenna housed in the watch casing, and a metallic dial.

As shown by the prior art, radio-controlled wrist watches are known in a multitude of variations. They are suitable for receiving, decoding and representing in visible form the corresponding time signals, which are emitted by a long wave time signal sender, on a display and/or by time hands. Most radio-controlled wrist watches switch each day at least twice automatically to the receiving function in order to receive the corresponding time signals that are emitted by the time signal sender and to subsequently adjust the clock time in accordance with this standard. For the rest of the day further operation is effected by means of an internal quartz work.

Long wave time signal senders emit generally at frequencies of between 20 and 100 kHz. Correspondingly, in Japan there are, for example, two time signal senders emitting at send frequencies of 40 to 60 kHz. DCF77, the only German time signal sender to date, sends at a frequency of 77.5 kHz.

The big challenge for engineers working on the development of radio-controlled wrist watches lies in ensuring the consistency of adequate reception of the radio-controlled signals while preserving a watch case of the kind that is customary for wrist watches, in particular utilizing the same kinds of materials that are currently in use for the production of wrist watch cases.

Because the reception of an antenna is disrupted in the neighborhood of a conductive material, i.e. in particular metallic materials, early-model radio-controlled wrist watches had the long wave antenna disposed outside of the metallic wrist watch case. Correspondingly, it is known, for example, from DE 35 08 366 A1 or from DE 88 15 967 U1 to incorporate the antenna into the wrist band. An arrangement of that kind has the disadvantage that because of its exposed position the antenna is vulnerable to breakage. Moreover, there is the risk that the electrical connection between the antenna and the clockwork is disrupted by mechanical stresses.

Newer developments target ways to dispose the antenna inside the watch case. With that arrangement the mechanical and electrical connection between clockwork and antenna is less susceptible to outside interferences.

From DE 93 18 224 U1 (corresponding to DE 4441424A1) it is known to insert the long wave antenna into a non-metallic watch case. It is proposed that the dial and the long wave antenna be disposed close to each other with the dial being completely, or at least a portion thereof, located in the proximity of the antenna, formed of a non-metallic material. As it has turned out, due mainly to aesthetic considerations, the use of a case that is made of a non-metallic material does not resonate among consumers in the marketplace at all, or only to a very limited degree. Furthermore, as in the case of the dial, the use of standard components is not possible here to achieve the desired mechanical properties, the optical appearance-specific characteristics that are familiar to and sought by the customer.

DE 296 07 866 discloses the incorporation of the long wave antenna in a clockwork with a metallic axially middle part, i.e., a part disposed between the watch glass and the floor of the watch case in a direction parallel to the axis of the hands. But this printed specification also teaches that the antenna be displaced in axially as far as possible away from the axial center of the watch case, and preferably placed inside a plastic floor or underneath the watch glass. Furthermore, also to be observed is a radial minimal spacing of the antenna from the metallic middle part. An arrangement underneath the watch glass is, on the one hand, only possible for air-cored antennas and is perceived, on the other hand, as disruptive by the customer because of the visibility of the antenna. Any arrangement with the antenna in a plastic floor is also often not an option for aesthetic reasons.

DE 299 23 446 U1 (corresponding to U.S. Pat. No. 6,411,569, the disclosure of which is incorporated by reference herein), is the basis (starting point) of the present invention. That patent discloses a radio-controlled wrist watch with a magnetic long wave antenna that is incorporated inside the watch case. The case of this radio-controlled wrist watch comprises a ring-shaped metal axially middle part (by “axially” is meant in the axial direction of the casing, e.g., parallel to the axis of the shaft to which the hour/minute hands are attached), and a floor formed of a non-conducting material. With regard to the metal middle part of the case, the antenna core of the long wave antenna is radially offset relative to the center of the case; but it is located near the metal axially middle part. To ensure an all-around radial distance of the antenna core relative to the inside wall of the electrically conducting case's axially middle part, an injection-molded plastic spacer ring is inserted between the case's axially middle part and the antenna. Even though, in principle, this configuration has proved itself, the dial is comprised quite uncommonly of an electrically non-conducting material in order to ensure adequate reception of the radio-controlled signals.

Therefore it is an object of the present invention to design and improve a radio-controlled wrist watch of the type described above in such a way as to allow for the possibility of using as further components those of a customary wrist watch with a quartz clockwork or a purely mechanical clockwork.

### SUMMARY OF THE INVENTION

This object is achieved by a radio-controlled wrist watch which comprises a watch case in which are housed a dial and a signal-receiving antenna. The dial comprises a metallic material and defines an axis. The antenna is spaced at an axial distance from the dial of more than 0.5 mm.

The radio-controlled wrist watch according to the invention differs from wrist watches according to the prior art in that the dial thereof is formed of a metallic (electrically conductive) material, instead of a non-conducting (in particular non-metallic) material. The antenna for receiving the time signals is still disposed inside the watch case, but it is disposed more than 0.5 mm away from the metallic dial. It has been shown that this distance is enough to ensure adequate reception, which runs contrary to the predominant opinion to date postulating that due to the minimal dimensions the use of a metallic dial is not possible at all without disruption to the reception of the time signal in such as way that any useful evaluation is no longer possible.

Even though it could be shown that this distance of more than 0.5 mm is sufficient, for reasons of observable manufacturing tolerances, it is beneficial if the magnetic long wave antenna is arranged at a distance of 1 to 4 mm relative to the metallic dial. On the one hand, a distance of this kind can be reliably adjusted at the time of assembly and, on the other hand, the tuning of the resonant antenna circuit is simplified because the electromagnetic interaction between antenna and metallic dial is comparatively low.

The antenna is usually disposed at a distance of 2 to 3 mm relative to the metal dial thereby limiting the axial need for assembly space as compared to what has been customary to date for radio-controlled wrist watches featuring non-metallic dials.

Even though it is possible, in principle, to produce dials of different metallic materials or materials with metallic coatings, a particularly advantageous embodied variant of the invention envisions that the dial be comprised of brass in its entirety. Thanks to their easy workability, brass dials are usually employed in quartz wrist watches or mechanical wrist watches. Moreover, this material constitutes the ideal basis for the majority of concept variations of a wrist watch design.

It has been shown that with the above described suitable selection of a distance between antenna and metal dial it is possible to use the customary dials of the usual thickness. The dial, in particular the brass dial, has ideally a thickness of 0.5 to 1 mm.

It has been demonstrated that, in principle, any kind of antenna can be used provided the distance is selected in accordance with the principles set forth above. In particular, it is possible to employ linear, rod-shaped ferrite antennas, such as, for example, described in DE 93 18 224 U1 or in DE 299 23 446 U1, or arc-shaped curved antennas having a core of flexible soft-iron vanes, such as, for example, described in EP 0 896 262 A1, or short coil antennas, such as, for example, described in EP 0 382 130 B2, or also long wave antennas with or without core and of different designs, such as, for example, described in DE 296 07 866 UL. In particular in the case of a linear, rod-shaped ferrite antenna of the kind described above, or in the case of an at least in part arc-shaped curved lamellar antenna, it is advantageous to arrange the antenna asymmetrically relative to a clock hand axis, if such hands were present. The clockwork can then be disposed comfortably in the same plane as the antenna and adjacent to the latter.

As a matter of principle, the metal dial can be used in combination with a non-metallic case. However, due to the fact that a non-metallic case is not very well received by customers, as outlined above, according to the invention the metallic dial is used in the context of a preferred embodied variant in conjunction with a case having a metallic axially middle part, such as, for example, described in DE 299 23 446 UL. Conceivable materials for the metal middle part are in particular: plastics (for example, produced by an injection-molding process) or ceramics, with a metallic coating, e.g., stainless steel or titanium.

As previously indicated, it is not necessary that the antenna be arranged far outside of the axial center of the case. If a sufficient (axial) distance is maintained relative to the metallic dial and a sufficient (radial) distance relative to the metallic axially middle part, even though the antenna is axially arranged in the area of the metallic axially middle part of the case (or, in other words, in the plane of the metallic axially middle part of the case), the signal-receiving functionality is ensured for the antenna.

In order to minimize any disruption of the receiving properties of the antenna due to the neighboring metallic and/or electrically conducting components of the wrist watch, in particular the metal dial and, if need be, of the metallic axially middle part, the invention envisions that the antenna be immovably fixed in place inside the watch case relative to the dial and, if need be, relative to the metallic axially middle part of the case. Immovable fixation in place is to be understood to mean that the position of the antenna relative to the adjacent metallic part will not change under normal operating conditions during wear of the wrist watch by the user.

In order to adjust the above designated minimum distance between the antenna and the metallic axially middle part of the case and in order to maintain this distance, if need be, as far as possible, i.e. in order to fix the antenna in place, if necessary, at that distance, the invention envisions a middle-part spacer between the metallic axially middle part of the case and the antenna; in particular, this is a spacer ring comprised of an electrically nonconducting material that maintains the antenna at a preset (radial) distance relative to the metallic axially middle part of the case.

For similar reasons the invention further envisions in a particularly advantageous configuration the use of a dial spacer between the dial and the antenna comprised of an electrically non-conducting material which maintains the antenna at a preset (axial) distance relative to the dial.

Suitable materials for the two spacers, i.e. the dial spacer and the middle-part spacer, are plastic materials (for example, as molded-injection parts) or ceramics. Both spacers can be manufactured independently of each other and can, if necessary, be comprised of different respective materials. But it is also possible to configure the dial spacer and the case middle part spacer as being made of identical materials and/or in one piece.

It has proved advantageous if the dial spacer is configured as a bottom plate that holds a clockwork and/or the antenna in place. The bottom plate correspondingly not only fulfills the function of holding the clockwork but also the distance-creating functionality with regard to the antenna. Aside from the function of the forced distance creation between the antenna and the dial (and, if need be, between the antenna and the housing middle part), the bottom plate can also comprise a holding device for the antenna, e.g., the bottom plate could include an integral, one piece element for holding the antenna. The functionality of fixing the antenna in place relative to the dial and preferably also relative to the (if need be, metallic) middle part is in this instance also taken over by the bottom plate.

To ensure an unmovable connection and therefore a, for the most part, preset positioning of the antenna relative to the dial and, if need be, the metallic middle part, it is envisioned according to the invention that the dial spacer, in particular the bottom plate, is connected to the dial by a type of plug connector.

Adequate receiving properties that allow for transforming the received time signals into a corresponding clock time without complex error correction or disruption suppression is achieved when the antenna has an antenna coil with an inductivity that exceeds a value of 1 millihenry (mH).

At the current time it is not possible without a complex design of a metal floor to ensure adequate reception for an antenna inserted in a metallic surrounding case (frame of the wrist watch case) in combination with a metallic dial. For manufacturing-technical considerations the invention therefore envisions a floor comprised of an electrically nonconducting material, in particular of plastic or glass.

### BRIEF DESCRIPTION OF DRAWING

Subsequently, the invention will illustrated in more detail by way of the drawing.

FIG. 1: FIG. 1a) A top view of a dial with placed-on component-carrying bottom plate of a first embodied example of a radio-controlled wrist watch according to the invention; FIG. 1b) A cross-sectional view of the dial with placed-on bottom plate in accordance with FIG. 1a; FIG. 1c) A detail view of a plug connector device between dial and bottom plate of the apparatus in accordance with FIGS. 1a and 1b.

FIG. 2: FIG. 2a) A top view of a dial with placed-on component-carrying bottom plate of a second embodied example of a radio-controlled wrist watch according to the invention; FIG. 2b) A cross-sectional view of the dial with placed-on bottom plate in accordance with FIG. 2a; FIG. 2c) A detail view of a plug connector device between dial and bottom plate of the apparatus in accordance with FIGS. 2a and 2b.

FIG. 3: A first embodied example of a resonant circuit of an antenna for a radio-controlled wrist watch according to the invention.

FIG. 4: A second embodied example of a resonant circuit of an antenna for a radio-controlled wrist watch according to the invention.

FIG. 5: A partial axial section through a prior art wristwatch showing the type of casing in which the present invention can be incorporated.

### DETAILED DESCRIPTION OF PREFERRED EMBODIMENTS OF THE INVENTION

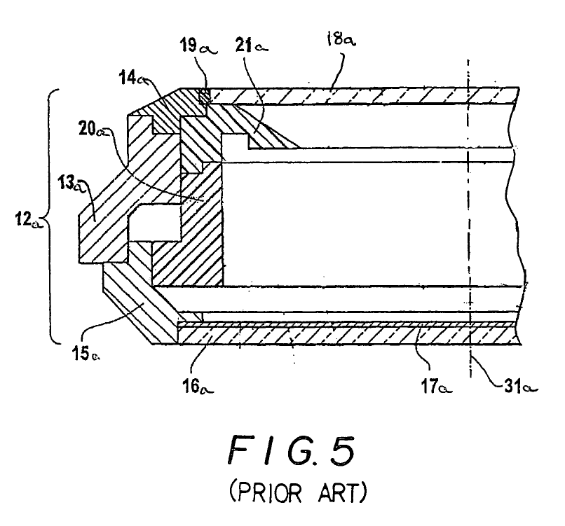

Depicted in FIG. 5 is a conventional radio wristwatch case 12a shown in axial longitudinal section. The case 12a defines a center axis 31a and has an axially central part 13a made from electrically conductive material, e.g. titanium. In this case it may involve a non-metallic injection-moulded part having a metallic coating, but is preferably a solid but radially thin stainless steel or titanium ring. The central part 13a is disposed axially between a glass collar 14a and a base ring 15a. The parts 14a and 15a may be made from a possibly electrically conductive material such as steel. However, in the case of electrically conductive rings 14a, 15a, they should not radially extend substantially beyond the central part 13a into the axial center of the wristwatch case.

The base or floor 16a is snapped into the housing 12a and comprises a rigid plate made from electrically non-conductive material, in particular ceramics or glass. The latter can have a coating 17a on its surface facing towards the interior of the housing, which coating is configured decoratively or informatively through the glass base 16a. Opposite said base, the watch glass 18a is fitted into the case 12a in the conventional manner by means of a sealing ring 19a.

A spacer ring 20a made from electrically non-conductive material, in particular from injection-moulded plastic, is disposed inside the case 12a and extends substantially further than the rings 14a, 15a, toward the axial center of the case 12a. The spacer ring 20a serves directly and/or by means of its face ring 21a as a clockwork mechanism ring, i.e., as a mounting for the clockwork mechanism in the case 12a.

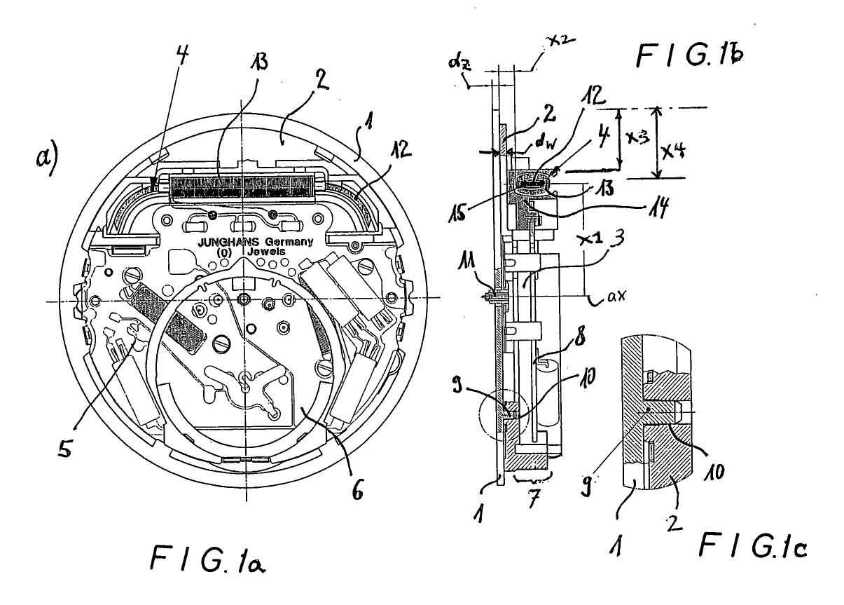

FIGS. 1a-c demonstrate the essential components of a first embodied example of a radio-controlled wrist watch according to the invention.

As used herein, the term “axially” refers to the axis of the watch, e.g., the axis of the drive shafts 11 to which hands (not shown) would be attached, if hands were provided. By the expression “axially middle part” is meant a part located between axially spaced front and rear ring-shaped parts of the case, but not necessarily at the exact middle.

A brass dial 1 is inserted in the case. The brass dial 1 is configured identically to a dial usually inserted in quartz wrist watches. It has a thickness d_{z} of approximately 0.5 to 1 mm.

A bottom plate 2 is placed onto brass dial 1. Bottom plate 2 is also configured corresponding to common practice. It is comprised of plastic and produced by an injection-molding procedure. Bottom plate 2 serves to hold these items in place: clockwork 3, a magnetic long wave antenna in the form of a lamellar antenna 4 for receiving time signals, electronics 5 that serve to control and regulate the clockwork, and a battery 6. The thickness d_{w} of bottom plate 2 is generally 0.5 to 1 mm.

An integral component of bottom plate 2 is, in the present embodied example, an axially extending work holder ring 7 that circumgrips the outer peripheral edge of the clockwork 3, as well as the electronics 5 and battery 6. In the present embodied example, work holder ring 7 is not continuous in the area of antenna 4, but the work holder ring could instead be configured as continuous, as described for example in DE 299 23 446 U1. The axial extension of work holder ring 7 is preset in the present instance by the position of printed circuit board 8 that is supported against the work holder ring 7 and that provides space for receiving the electronic components. But it would also be possible to forego work holder ring 7; or said ring could extend, for example, down to the floor of the watch case.

Bottom plate 2 is rigidly connected in the present embodied example to brass dial 1. This rigid connection is achieved by way of a plug connector device. The plug connector device comprises, in accordance with FIGS. 1b) and 1c), several pins 9 that engage, essentially complementary in shape and function, in corresponding recesses of the bottom plate 2, preferably bore holes 10 formed in bottom plate 2.

Clockwork 3 is in the present embodied example a clockwork with hands. The shaft 11 that drive the hands (not shown here) penetrate bottom plate 2 and brass dial 1 centrally, i.e., along the axis aₓ.

Lamellar antenna 4 is configured similarly to the magnetic long wave antenna in document EP 0 896 262 A1. It comprises a laminated core 12 of a pile of flexible strips of a soft-magnetic material (e.g. amorphous lamellar material) of high permeability carrying an antenna coil 13. The inductivity of the antenna coil is equal to or larger than one millihenry (1 mH).

Lamellar antenna 4 is disposed asymmetrically relative to clock hand axis ax and in the same axial position as the ring-shaped metallic case middle part. The radial distance x₁ from clock hand axis ax to antenna axis 15 is 10 mm in the present embodied example.

Lamellar antenna 4 is inserted in a receiving sleeve 14 that receives and encloses almost completely the antenna coil 13 and the arc-shaped ends of antenna core 12 that extend on both sides beyond antenna coil 13. Receiving sleeve 14 is comprised of an electrically non-conducting material, preferably plastic. In the present embodied example the receiving sleeve is configured as a separate component that is placed onto bottom plate 2 and that is preferably rigidly connected to the latter. But receiving sleeve 14 could alternatively be designed in one piece and/or made of the same material as bottom plate 2.

Receiving sleeve 14 serves, in conjunction with bottom plate 2, to secure and forcibly hold the distance of antenna 4 relative to brass dial 1 and relative to the surrounding metallic case middle part. The axial distance x₂ between dial 1 and antenna 4 is 1.4 mm in the present embodied example. Distance Radial distance X₃ between case middle part and antenna coil 13 is 8 mm. Radial distance ax between case middle part and antenna core 12 is 10 mm.

Aside from the use of the receiving sleeve 14, it would be additionally possible to provide a distance ring of the kind as described in DE 299 23 446 U1 that acts to forcibly maintain a distance. Naturally, the ring can be made of the same material as, and, if need be, in one piece with bottom plate 2.

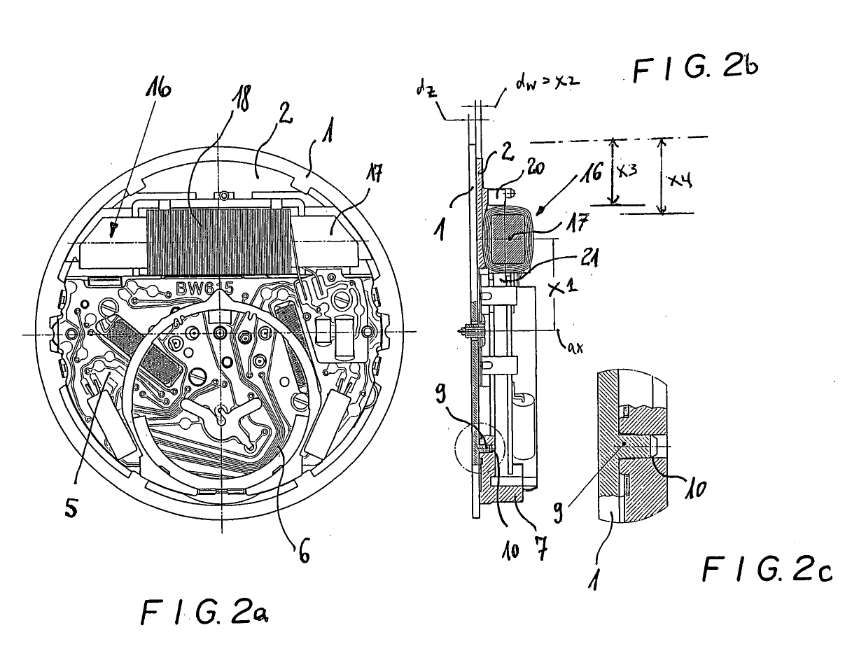

FIG. 2a-c shows the essential components of a second embodied example of a radio-controlled wrist watch according to the invention. This radio-controlled wrist watch corresponds in all essential aspects to the details set forth in the embodied example according to FIG. 1a-c. Components that are identical and/or equal in terms of function are therefore designated by the same reference numerals.

A brass dial 1 is inserted in the case which is not shown. Brass dial 1 is identical to the one that is configured in accordance with FIG. 1. It has a thickness d_{z} of approximately 0.5 to 1 mm.

Here too, a bottom plate 2 of the previously described type is placed onto brass dial 1 and immovably connected to the dial by way of pins 9 that engage in corresponding bore holes 10. Bottom plate 2 serves for holding the following items in place: a clockwork 3, a magnetic long wave antenna in the form of a ferrite antenna 16 for receiving time signals, electronics that control and regulate clockwork 3 as well as battery 6. The thickness dw of bottom plate 2 is 0.5 to 1 mm in the present instance as well.

An integral component of bottom plate 2 is a work holder ring 7 that circumgrips clockwork 3 on the side of the periphery in the present embodied example as well.

Ferrite antenna 16 is configured similarly to the magnetic long wave antenna described in document DE 299 23 446 U 1. It comprises an extended prismatic antenna ferrite core 17 that carries antenna coil 18. The inductivity of the used antenna coil is larger/equal to one millihenry (1 mH).

Ferrite antenna 16 is asymmetrically arranged relative to indicator axis ax and in the same axial position as the ring-shaped metallic case middle part. The radial distance x1 from clock hand axis ax to antenna axis 19 is 8 mm in the present embodied example.

In the present instance, ferrite antenna 16 is directly placed onto bottom plate 2. It is held in place by two collars 20, 21 that are disposed onto bottom plate 2 parallel relative to each other. A sleeve-shaped enclosing of ferrite antenna 16 is not envisioned.

Bottom plate 2 serves in this case exclusively for the purpose of maintaining the forced distance between antenna 16 and brass dial 1. The axial distance x2 between dial 1 and antenna 16 in the present embodied example is therefore identical to the thickness dw of the bottom plate and is approximately 0.5 to 1 mm. The distance x3 between case middle part and antenna coil 18 is 0.5 mm. The radial distance x4 between case middle part and antenna core 17 is 1.3 mm.

Due to the fact that in this case no receiving sleeve 14 is provided, a forced distance-creating distance ring of the kind described in DE 299 23 446 U1 (but not shown here) is envisioned. Naturally, such a ring could be formed of an identical material as or, if need be, in once piece with bottom plate 2.

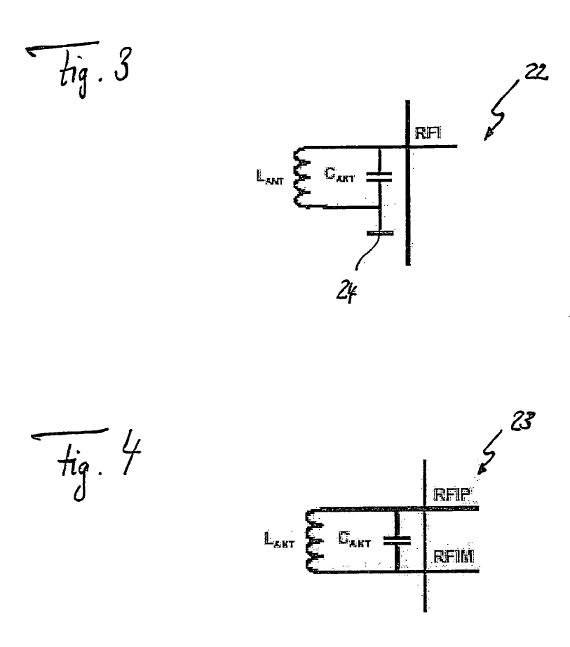

Conceivable resonant antenna circuits are, in principle, any and all circuit kinds that are known in the art. FIGS. 3 and 4 represent examples of resonant antenna circuits. FIG. 3 demonstrates a resonant antenna circuit with so-called “single-ended input;”

FIG. 4 illustrates a resonant antenna circuit with so-called “differential input.”

“Single-ended input” resonant antenna circuit 22 in accordance with FIG. 3 comprises a parallel connection based on antenna inductivity L_{ANT} that is preset by used antenna 4, 16 (amorphous, ferrite) and antenna capacity C_{ANT} the one terminal of which is connected to a reference potential. The RFI terminal is connected to the unsymmetrical antenna input of the receiver ICs.

“Differential input” resonant antenna circuit 23 in accordance with FIG. 4 comprises a parallel connection based on antenna inductivity L_{ANT} and antenna capacity C_{ANT} the one terminal of which is connected to a reference potential. The RFIP terminal is connected to the positive symmetrical antenna input of the receiver ICs. The RFIM terminal is connected to the negative symmetrical antenna terminal of receiver ICs.

The resonance frequency of the respective resonant antenna circuit is tuned to maximum voltage gain for the receiving frequency, dependent on dial and case material. Coupling of the resonant antenna circuit occurs symmetrically or asymmetrically.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. A radio-controlled wrist watch comprises a watch case in which are housed a dial and a signal-receiving antenna, the dial comprising a metallic material and defining an axis, the antenna spaced at an axial distance from the dial of more than 0.5 mm.

2. Radio-controlled wrist watch as claimed in claim 1 wherein the axial distance is in the range of 1 to 4 mm.

3. Radio-controlled wrist watch as claimed in claim 1 wherein the distance is in the range of 1 to 3 mm.

4. Radio-controlled wrist watch as claimed in claim 1 wherein the dial comprises brass.

5. Radio-controlled wrist watch as claimed in claim 1 wherein the dial has a thickness in the range of 0.5 to 1 mm.

6. Radio-controlled wrist watch as claimed in claim 1 wherein the antenna is arranged asymmetrically relative to the axis.

7. Radio-controlled wrist watch as claimed in claim 1 wherein the watch case includes a metallic axially middle part.

8. Radio-controlled wrist watch as claimed in claim 1 wherein the antenna is arranged substantially in a plane defined by a metallic axially middle part of the case.

9. Radio-controlled wrist watch as claimed in claim 1 wherein the antenna is immovably fixed in place inside the watch case relative to the dial.

10. Radio-controlled wrist watch is claimed in claim 8, further including an antenna spacing member comprising an electrically non-conductive material disposed radially between the metallic axially middle part and the antenna for maintaining the antenna at a preset distance relative to the metallic axially middle part.

11. Radio-controlled wrist watch as claimed in claim 10 wherein the antenna-spacing member comprises a sleeve in which the antenna is disposed.

12. Radio-controlled wrist watch as claimed in claim 10 wherein the antenna-spacing member comprises a spacer ring.

13. Radio controlled wrist watch as claimed in claim 1, further including a dial spacer comprising an electrically non-conductive material disposed axially between the dial and the antenna for maintaining the antenna at a preset axial distance relative to the dial.

14. Radio-controlled wrist watch as claimed in claim 13 wherein the dial spacer comprises a bottom plate securing in place a clockwork.

15. Radio-controlled wrist watch as claimed in claim 14 wherein the bottom plate also secures the antenna in place.

16. Radio-controlled wrist watch as claimed in claim 13 wherein the dial spacer comprises a bottom plate securing the antenna in place.

17. Radio-controlled wrist watch as claimed in claim 13 wherein the dial spacer is connected to the dial by a plug-and recess coupling.

18. Radio-controlled wrist watch as claimed in claim 1 wherein antenna includes an antenna coil having an inductivity (L_{ANT}) exceeding a value of 1 millihenry (mH).

19. Radio-controlled wrist watch as claimed in claim 1 wherein the watch case includes a floor comprised of an electrically non-conducting material including one of plastic, ceramics or glass.

20. Radio-controlled wrist watch as claimed in claim 1 wherein the resonance frequency of the respective resonant antenna circuit is tuned for maximum voltage gain of the time signal sender frequency.
